(19) United States
(12) Patent Application Publication
(10) Pub. No.: US 2016/0042731 A1
(43) Pub. Date: Feb. 11, 2016

(54) SYSTEM AND METHOD FOR CONTROLLING VEHICLE NOISE

(71) Applicant: Hyundai Motor Company, Seoul (KR)

(72) Inventor: Kyoung-Jin Chang, Suwon (KR)

(21) Appl. No.: 14/548,039

(22) Filed: Nov. 19, 2014

(30) Foreign Application Priority Data
Aug. 11, 2014 (KR) 10-2014-0103941

(51) Int. Cl. G10K 11/175

(52) U.S. Cl. CPC G10K 11/175

(57) ABSTRACT

A noise control system and a method are provided. The method includes receiving, by a controller, a reference signal in response to a noise and an error signal that corresponds to residual noise. A control signal is generated for cancelling the noise based on the reference signal. In addition, the controller outputs a vibration according to the control signal to generate a cancellation signal for cancelling the noise. A phase delay of the reference signal is compensated for by the controller and updates a filter value of the adaptive filter based on the reference signal passing through the path compensation filter and the error signal.

### CROSS-REFERENCE TO RELATED APPLICATION(S)

Pursuant to 35 U.S.C. §119(a), this application claims the benefit of Korean Patent Application No. 10-2014-0103941 filed on Aug. 11, 2014, the entire contents of which are incorporated herein by reference in its entirety.

### BACKGROUND

1. Field of the Invention

The present invention relates to a system and method for controlling noise, and more particularly, to a system and method for actively controlling noise, which reduces noise within a vehicle.

2. Description of the Related Art

In general, a passive method of using a sound absorbing material, a soundproofing material, and the like is used as a method of reducing noise within a vehicle. However, such passive noise reducing methods are limited. Recently, an active noise control technique for reducing noise by generating a signal having an opposite phase to that of the noise using a sound output device, such as an audio speaker, has been developed. Various noises may be generated while driving including noise from a vehicle engine and noise generated by friction between the tires and a curved road surface, and the like. Recently, to improve driver ride comfort, research for applying active noise control techniques have been conducted to reducing noise within a vehicle.

However, when a sound output device, such as a speaker, is used for reducing noise within a vehicle, the resultant sounds may feel artificial or unnatural to a user. Further, active noise control techniques which employ an opposite phase signal output from audio speakers suffer from problems including no effectively removing low frequency noise, such as a booming sound of an engine.

The above information disclosed in this background section is merely for enhancement of understanding of the background of the invention and therefore it may contain information that does not form the prior art that is already known in this country to a person of ordinary skill in the art.

### SUMMARY

The present invention provides a system and method for controlling noise within an operating vehicle.

According to an exemplary embodiment of the present invention, a system for controlling noise may include: a memory configured to store program instructions; and a processor configured to execute the program instructions, the program instructions when executed configured to receive a reference signal in response to a sound or vibration generated by a noise source; receive an error signal that corresponds to residual noise from the sound or the vibration; generate a control signal for cancelling the noise by the noise source based on the reference signal; compensate for a phase delay of the reference signal; update a filter value of the adaptive filter based on the reference signal passing through the path compensation filter and the error signal; and output vibration according to the control signal to generate a cancellation signal for cancelling the noise.

Another exemplary embodiment of the present invention provides a method of controlling noise by a noise control system, that may include: receiving, by a controller, a reference signal in response to a sound or vibration generated by a noise source; generating, by the controller, a control signal for cancelling noise by the noise source based on the reference signal passed through an adaptive filter; vibrating, by the controller, a vibration generator according to the control signal to generate a cancellation signal for cancelling the noise; compensating for a phase delay of the reference signal, by the controller; and updating, by the controller, a filter value of the adaptive filter based on the reference signal and the error signal, wherein the phase delay of the filter value is compensated for; and receiving, by the controller, an error signal that corresponds to residual noise. The adaptive operation may include: compensating for a phase delay of the reference signal; and updating a filter value of the adaptive filter based on the reference signal, for which a phase delay is compensated for, and the error signal.

Yet another exemplary embodiment of the present invention provides a non-transitory computer readable medium containing program instructions executed by a controller for executing the method of controlling noise of the present invention. According to an exemplary embodiments of the present invention, it may be possible to effectively remove indoor noise generated by vibration. Further, it may be possible to more stably control noise by preventing a noise control signal from being diverged.

### BRIEF DESCRIPTION OF THE DRAWINGS

FIG. 1 is an exemplary diagram illustrating a noise control system according to an exemplary embodiment of the present invention;

FIG. 2 is an exemplary diagram illustrating a vibration generating unit according to an exemplary embodiment of the present invention;

FIG. 3 is an exemplary diagram illustrating an error signal obtaining unit according to an exemplary embodiment of the present invention;

FIGS. 4 and 5 illustrate exemplary examples in which the noise control system according to an exemplary embodiment of the present invention may be installed in a vehicle;

FIG. 6 is an exemplary diagram illustrating a controller according to an exemplary embodiment of the present invention;

FIG. 7 is an exemplary diagram for describing an operation of the controller according to an exemplary embodiment of the present invention;

FIG. 8 is an exemplary flowchart illustrating a noise control method according to an exemplary embodiment of the present invention; and

FIG. 9 is an exemplary flowchart illustrating an adaptation control method of the noise control system according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although the exemplary embodiments are described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element.

Hereinafter, a noise control system according to an exemplary embodiment of the present invention, and a method thereof will be described with reference to the drawings. In an exemplary embodiment of the present invention, a noise control system may be configured to adapt a filter by using a filtered-X least mean square (LMS) algorithm, which is a narrow band feed-forward adaptation control algorithm, as an adaptation control algorithm. In other words, the noise control system may be configured to adaptively update a filter value used in generation of a control signal using the filtered-X LMS algorithm. The LMS algorithm is an algorithm for automatically adjusting a filter value of a filter using a difference between a target response and an actual response, (e.g., an error signal), and is an algorithm for updating a filter value to minimize an expectation value of a square of the error signal, that is, a mean square error.

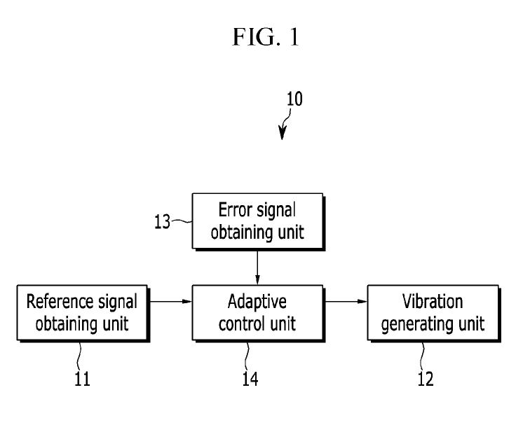

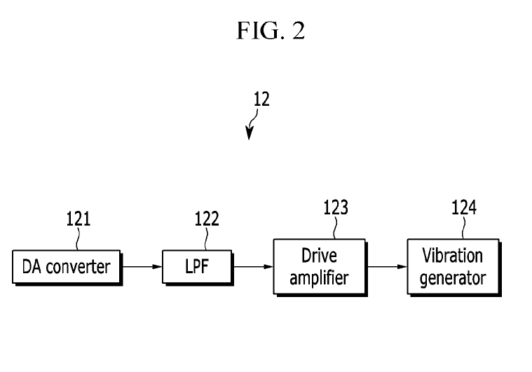

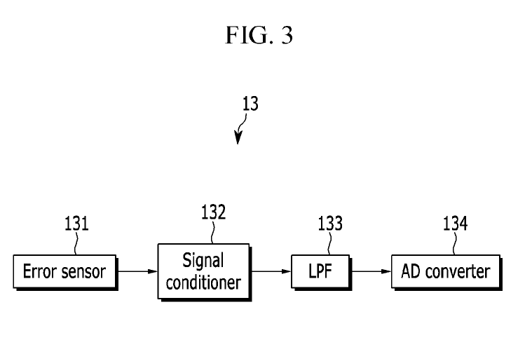

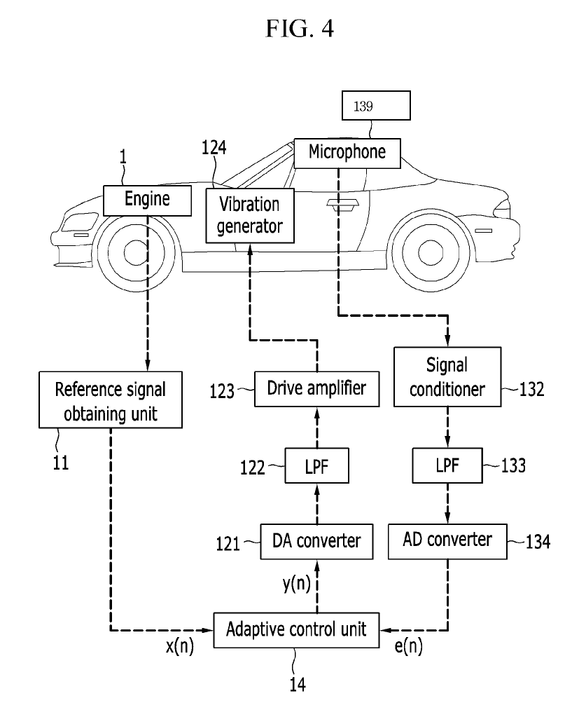

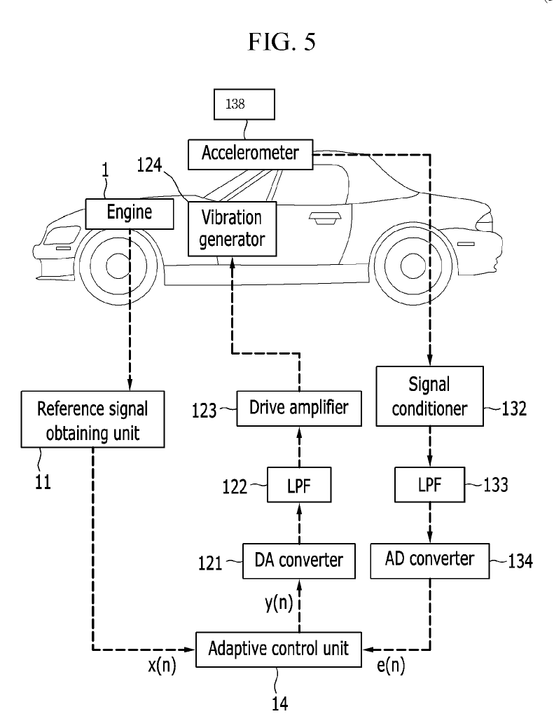

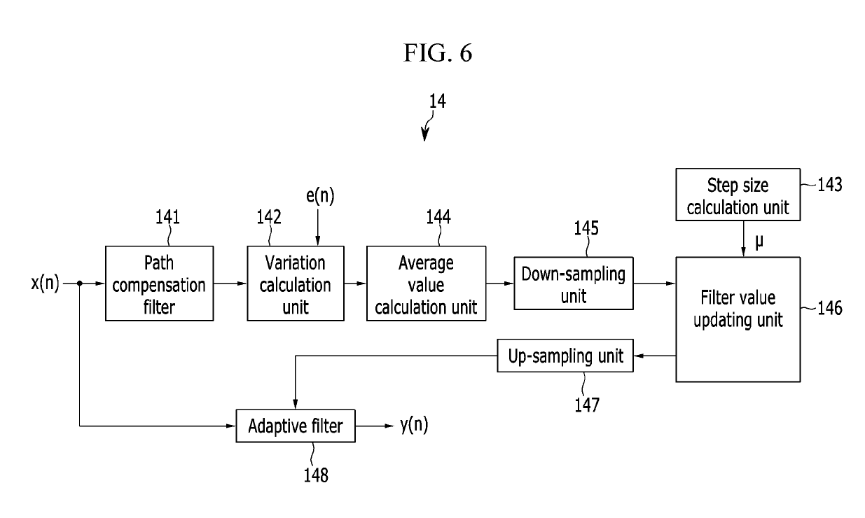

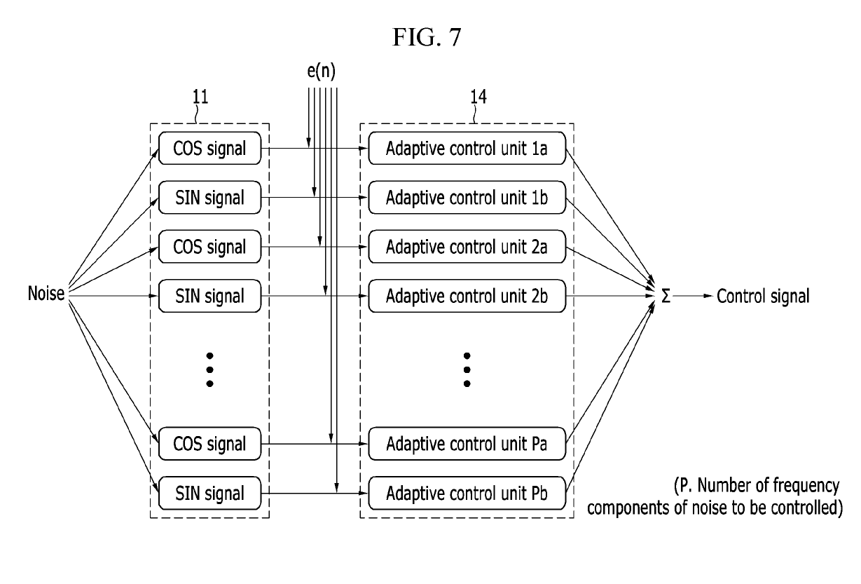

FIG. 1 is an exemplary configuration diagram illustrating a noise control system according to an exemplary embodiment of the present invention. FIG. 2 is an exemplary configuration diagram illustrating a vibration generating unit according to an exemplary embodiment of the present invention, and FIG. 3 is an exemplary configuration diagram illustrating an error signal obtaining unit according to an exemplary embodiment of the present invention. Further, FIGS. 4 and 5 illustrate exemplary embodiments in which the noise control system according to an exemplary embodiment of the present invention is installed in a vehicle. Further, FIG. 6 is an exemplary configuration diagram illustrating a controller according to an exemplary embodiment of the present invention, and FIG. 7 is an exemplary diagram for describing an operation of the controller according to an exemplary embodiment of the present invention.

Referring to FIG. 1, a noise control system 100 according to an exemplary embodiment of the present invention may include a reference signal obtaining unit 11, a vibration generating unit 12, an error signal obtaining unit 13, an adaptive controller 14, and the like, and in general, controller 14 executes the other listed units. It should be noted that the constituent elements illustrated in FIG. 1 may not all be essential or limiting, that is, the noise control system 100 according to an exemplary embodiment of the present invention may be provided so as to include more or fewer constituent elements than those illustrated.

The reference signal obtaining unit 11 may be configured to obtain a reference signal in response to vibration or a sound generated by a noise source. A reference signal is a signal that corresponds to a sound wave feature of noise which is a cancellation target, and may include a plurality of frequency components. By way of example, the reference signal may include a plurality of cosine signals and sine signals synchronized to a sound wave feature of noise that is a cancellation target. There may be various types of sound sources causing noise within a vehicle. For example, the sound source may be an engine rotation or friction due to a curved road surface.

When the noise source is the engine rotation, engine noise may be synchronized to revolutions per minute (RPM) of the engine. Accordingly, the reference signal obtaining unit 11 may be configured to obtain information regarding the RPM of an engine to generate a reference signal. Further, the reference signal obtaining unit 11 may be configured to obtain a plurality of frequency components causing the engine noise based on the RPM of the engine, and generate a reference signal to include a sine signal and a cosine signal that correspond to the obtained frequency components.

The reference signal obtaining unit 11 may be configured to receive the information regarding the RPM of the engine from an electronic control unit (ECU) of the vehicle via controller area network (CAN) communication. Further, the reference signal obtaining unit 11 may be configured to receive a pulse signal from a crank position sensor, which may be configured to detect a rotation angle or a rotation position of a crank shaft of the engine, convert the received pulse signal to information regarding the RPM of the engine, and use the information regarding the RPM of the engine.

When the noise source is friction due to a curved road surface, noise generated by the friction may be synchronized to vibration of the vehicle according to the friction. Accordingly, the reference signal obtaining unit 11 may be configured to obtain information regarding vibration of the vehicle according to the friction due to the curved road surface in order to generate a reference signal. Further, the reference signal obtaining unit 11 may be configured to obtain a plurality of frequency components configuring the noise based on the information regarding the vibration of the vehicle, and generate a reference signal to include a sine signal and a cosine signal that corresponds to the obtained frequency components.

The reference signal obtaining unit 11 may be configured to obtain the information regarding the vibration of the vehicle according to the friction due to the curved curve road surface using an accelerometer 138. The accelerometer 138 may be installed at a position, to which vibration of the vehicle according to the friction due to the curved road surface is transmitted into the vehicle, and detect a change in acceleration according to the vibration of the vehicle, and output information regarding the vibration of the vehicle. The vibration generating unit 12 may be configured to generate vibration based on a control signal of the adaptive controller 14 which is described below.

Referring to FIG. 2, the vibration generating unit 12 may include a digital to analog converter (DA converter) 121, a low pass filter (LPF) 122, a drive amplifier 123, a vibration generator 124, and the like. When a control signal (e.g., a digital signal) is input from the adaptive controller 14 which is described below, the DA converter 121 may be configured to convert the control signal to an analog signal and output the analog signal. The low pass filter 122 may be a reconstruction filter or an anti-imaging filter. The low pass filter 122 may be configured to perform filtering of, and therefore remove, a mirror image from the control signal output from the DA converter 121. In general, the digital signal may include a mirror image repeated at every sampling frequency. Accordingly, the low pass filter 122 may be configured to remove the mirror image created by frequency components of one half or more of the sampling frequency from the control signal and outputs the mirror image. When the control signal passes through the DA converter 121, the low pass filter 122, and the like and may be input, the drive amplifier 123 may be configured to amplify the control signal to use the control signal as a drive signal of the vibration generator 124, and output the amplified control signal.

The vibration generator 124 may be configured to generate vibration in response to the control signal amplified and output by the drive amplifier 123. The vibration generator 124 may include a permanent magnet and a coil. When the control signal, (e.g. a current signal) is input from the drive amplifier 123, the permanent magnet and the coil of the vibration generator 124 may be configured to relatively vibrate to generate a vibration output. The vibration generator 124 may be an electro-dynamic type in which the coil relatively vibrates to the permanent magnet to generate a vibration output. Further, the vibration generator 124 may be an electro-magnetic type in which the permanent magnet relatively vibrates to the coil to generate a vibration output. The vibration output generated by the vibration generator 124 may be transmitted to a panel (not illustrated), and may vibrate the panel to generate a radiation sound. The radiation sound generated by the vibration of the panel may operate as a cancellation signal of the noise that is a removal target. The vibration output generated by the vibration generator 124 may be excited to include a frequency component of the noise that is a cancellation target.

For example, the engine noise that is a cancellation target may correspond to second/fourth/sixth components of an RPM of the engine or third/sixth/ninth components of the RPM of the engine. Accordingly, when the RPM of the engine is about 1,500 to 6,000 rpm, a frequency band of the engine noise that is the cancellation target may be about 50 to 600 Hz. To cancel the engine noise, the vibration output of the vibration generator 124 may need to be excited in the frequency band of about 50 to 600 Hz. Further, according to this example, an amplitude of the vibration of the vibration generator 124 may need to be set so that a sound pressure of a radiation sound of the panel, that is, an amplitude, is great enough to cancel noise. For example, when a removal target is the engine noise, to generate a radiation sound of the panel cancelling a maximum value of the noise, the vibration output of the vibration generator 124 is about 5 N to 30 N.

As described above, an attachment position, (e.g., an excitation position), of the vibration generator 124, may be disposed at a position sufficiently excited in a frequency band of the noise that is the cancellation target, and having a sufficient enough amplitude for a sound pressure of the radiation sound of the panel generated by transmission of exciting force to cancel the maximum value of the noise.

The excitation position of the vibration generator 124 may be improved or optimized through an experiment. In other words, a process of detecting a vibration output may be performed by changing the attachment position of the vibration generator 124, and installing the vibration generator 124 at a position at which an optimum cancelling signal is generated. Particularly, when a vibration sensor is used as an error sensor 131, which is described below, a transfer path (e.g., an upper/lower side of an engine mount, and a front/rear direction of a roll rod) having a largest influence on travelling noise within the vehicle may be selected through a transfer path analysis. In such an analysis, it may be necessary to test whether a sound pressure having an amplitude available for cancelling indoor noise may be generated by attaching the vibration generator 124 to the selected position, and optimize the excitation position of the vibration generator 124 based on a result of the test. When the optimum excitation position is set, the vibration generator 124 may be fixed to the panel within the vehicle to prevent a contact sound (rattle sound) from being generated due to the rotation, or the contact with the panel, of the vibration generator 124, even though a substantial vibration output may be generated.

Referring back to FIG. 1, the error signal obtaining unit 13 may be configured to an error signal in response to a sound or vibration at a predetermined position. The error signal, which is a result of destructive interference between the noise generated by the noise source and a cancellation signal generated by the vibration of the vibration generator 124, may be a signal that corresponds to residual noise. The noise control system 10 may be configured to actively reduce noise by continuously obtaining an error signal through the error signal obtaining unit 13, and continuously updating the control signal in a direction in which the error signal becomes a smallest value.

Referring to FIG. 3, the error signal obtaining unit 13 may include the error sensor 131, a signal conditioner 132, a low pass filter 133, an analog to digital converter (AD converter) 134, and the like. The error sensor 131 may be configured to detect a sound or vibration that corresponds to the residual noise at a specific position and output an error signal that corresponds to the detected sound or vibration. The error sensor 131 may include a sound sensor (not illustrated), such as a microphone. Referring to FIG. 4, when the error sensor 131 includes a microphone, the microphone 139 may be disposed at a specific position within the vehicle to obtain a sound signal at the corresponding position. Accordingly, such an output reference signal may correspond to the sound signal. The error sensor 131 may also include a vibration sensor (not illustrated), such as an accelerometer 138. Referring to FIG. 5, when the error sensor 131 includes an accelerometer 138, the accelerometer 138 may be attached to the panel within the vehicle to obtain a vibration signal at a corresponding position. Accordingly, such an output reference signal may correspond to the vibration signal detected in the panel.

The signal conditioner 132 may be configured to process the error signal output from the error sensor 131 according to a characteristic of the error sensor 131 and output the processed error signal. The low pass filter 133 may be an anti-aliasing filter, and may be configured to filter the error signal input through the signal conditioner 132 to prevent aliasing in the error signal, and output the filtered error signal. In the process of converting the analog signal to the digital signal, in order to prevent the generation of the aliasing, a sampling frequency may be minimally two times or greater of a maximum frequency of a signal that is a sampling target. Accordingly, the low pass filter 133 may be configured to remove a frequency component greater than one half of the sampling frequency from the error signal and output the error signal to cause frequency component included in the error signal to be one half or less than the sampling frequency of the AD converter 134, which is described below. When the error signal passing through the low pass filter 133 is input, the AD converter 134 may be configured to convert the input error signal to a digital signal, and output the converted digital signal to the adaptive controller 14.

Referring back to FIG. 1, the adaptive controller 14 may be configured to generate a control signal for noise cancellation based on the reference signal obtained through the reference signal obtaining unit 11. Further, the adaptive controller 14 may be configured to output the generated control signal to the vibration generating unit 12 to adjust a vibration output of the vibration generator 124. Further, the adaptive controller 14 may be configured to perform adaptive control for adapting a filter used in generation of the control signal in a direction of minimizing a mean square error based on the error signal obtained through the error signal obtaining unit 13.

Referring to FIG. 4, the adaptive controller 14 may include an adaptive filter 141, a path compensation filter 142, a variation calculation unit 143, a step size calculation unit 144, an average value calculation unit 145, a down-sampling unit 146, a filter value updating unit 147, an up-sampling unit 148, and the like. The adaptive filter 141 may be configured to generate a control signal that is an antiphase signal of the noise or the vibration to be cancelled based on the reference signal input from the reference signal obtaining unit 11. The adaptive filter 141 may be configured to use an infinite impulse response (IIR) or finite impulse response (FIR) transfer function in order to generate the control signal based on the reference signal, and a filter value of the transfer function may be updated by an adaptive algorithm, which is described below.

Equation 1 below represents a method of generating a control signal (y) based on the reference signal (x(n)) by the adaptive filter 141.

y(n)=w^{T}(k−1)×(n) Equation 1

Wherein, n is a sampling degree, and k is a number of a block. Further, wT(k−1) is a transfer function configured by a filter value for each frequency component. Each filter value of the transfer function (wT(k−1)) may be updated by the aforementioned adaptive algorithm. In an exemplary embodiment of the present invention, a filter value is updated in the unit of a block (k), and a currently applied filter value is a filter value calculated in a previous block (k−1).

The path compensation filter 142 may be configured to path-compensate for the reference signal output from the reference signal obtaining unit 11 and output the path-compensated reference signal. In other words, the path compensation filter 142 may be configured to compensate for a phase delay of the reference signal and output the compensated reference signal.

The transfer function used for compensating for the phase delay of the reference signal by the path compensation filter 142 may be determined by a transfer characteristic measured in a secondary path until the excitation force of the vibration generator 124 is detected by the error sensor 131. In other words, the transfer function may be a vibration transfer function obtained by measuring a transfer characteristic in that the excitation force of the vibration generator 124 may be transferred in the form of vibration or a sound wave in the path from the position at which the vibration generator 124 is installed to the position at which the error sensor 131 is installed.

According to an exemplary embodiment of the present invention, the noise control system 10 may be configured to use the vibration output of the vibration generator 124 as a noise control signal. In other words, the noise control system 10 may be configured to generate radiation sound for cancelling noise by vibrating the panel through the vibration generator 124. In particular, indoor noise may be controlled by using structure-borne noise generated by the vibration of the panel, to use a vibro-acoustic transfer function (e.g., a structure transfer function) may be used as a path transfer function in contrast to the related art where indoor noise is controlled by using air-borne noise. The path compensation filter 142 may be configured to use an impulse response transfer function as a transfer function for compensating for a path.

The impulse response transfer function used for compensating for the path may be set differently according to the type of error sensor 131 used. When the error sensor 131 is a sound sensor, the impulse response transfer function used for the path compensation filter 142 may be expressed by Equation 2 below.

A/F=(V/F)×(A/V) Equation 2

Wherein, A is an indoor sound pressure, and may be a sound pressure of a sound signal detected by the error sensor 131, F is an excitation force, and corresponds to the excitation force of the vibration generator 124, V is a vibration acceleration of the panel, and may be measured by a separate vibration sensor.

When the path compensation filter 142 of Equation 2 is used, the impulse response transfer function may be calculated based on excitation force (F) of the vibration generator 124 and a sound pressure (A) obtained by measuring each of the excitation force (F) of the vibration generator 124 and the sound pressure (A) at which a sound generated by the excitation force of the vibration generator 124 is detected by the error sensor 131. Further, as expressed in Equation 1, the impulse response transfer function may be calculated by measuring each of the vibration acceleration (V) of the panel against the excitation force (F) of the vibration generator 124, and the indoor sound pressure (A) against the vibration acceleration (V) of the panel. In the latter case, measuring the vibration acceleration against the excitation force, and the indoor sound pressure against the vibration acceleration may be necessary, to consider the vibration acceleration and the indoor sound pressure according to the excitation force, thereby allowing for optimization of an excitation position.

When the error sensor 131 is a vibration sensor, the impulse response transfer function used for the path compensation filter 142 may correspond to a vibro-vibro transfer function and may be expressed by Equation 3 below.

V/F=(A/F)×(A/V)⁻¹ Equation 3

Wherein, V is vibration acceleration, and may be detected by the vibration sensor, F is an excitation force, and corresponds to the excitation force of the vibration generator 124, and A is an indoor sound pressure, and may be measured by a separate sound sensor.

When the path compensation filter 142 of Equation 3 is used, the impulse response transfer function may be calculated based on excitation force of the vibration generator 124 and vibration acceleration (V) obtained by measuring each of the excitation force of the vibration generator 124 and the vibration acceleration (V) generated by the excitation force of the vibration generator 124. Further, as expressed in Equation 1, the impulse response transfer function may be calculated by measuring each of the indoor sound pressure (A) against the excitation force (F) of the vibration generator 124, and the indoor sound pressure (A) against the vibration acceleration (V). In the latter case, it may be necessary to measure the indoor sound pressure against the excitation force, and the indoor sound pressure against the vibration acceleration, to consider the various vibration accelerations and the indoor sound pressure according to the excitation force, thereby allowing for optimization of an excitation position.

In an exemplary embodiment of the present invention, as described above, the phase delay by the secondary path from the reference signal may be compensated for through the path compensation filter 142, thereby improving a convergence speed of the filter value. The reference signal passing through the path compensation filter 142 may be output to the variation calculation unit 143. The variation calculation unit 143 may be configured to calculate a filter variation quantity, (e.g., a variation quantity of the filer value), based on the reference signal that passes through the path compensation filter 142 to be path-compensated, and the error signal obtained by the error signal obtaining unit 13.

The variation calculation unit 143 may be configured to calculate the filter value for each frequency component included in the reference signal (x(n)), and a variation quantity (f(n)) of the filter value corresponding to each frequency component may be calculated through Equation 4 below.

f(n)=xₕₐₜ(n)×e(n)×μ Equation 4

Wherein, n is a constant indicating a sampling degree, xhat(n) indicates the reference signal (x(n)) path-compensated by the path compensation filter 142, and e(n) is an error signal obtained by the error signal obtaining unit 13. Further, μ indicates a step size, and may be calculated by the step size calculation unit 144 which is described below.

The step size calculation unit 144 may be configured to calculate a step size (μ) from the frequency response function measured in the secondary path from the vibration generator 124 to the error sensor 131. In the LMS algorithm, the step size (μ) may be a parameter for determining a convergence speed of the filter. When the step size is substantially small (e.g., smaller than a predetermined size), a convergence speed of the filter value may be substantially slow, (e.g., less than a predetermined speed), thus deteriorating control performance. However, when the step size is substantially large, (e.g., greater than a predetermined size), the filter is diverged, causing control stability to deteriorate considerably.

In an exemplary embodiment of the present invention, a frequency-based variable step size (μ(k)), in which a step size is adjusted differently for each frequency component, may be used through a normalized LMS algorithm expressed in Equation 5 below.

$$μ ( i ) = \frac{{μ}_{0}}{{S}_{rr} ( i )} \qquad Equation 5$$

Wherein, i indicates each frequency component configuring a frequency response function in the secondary path, μ(i) indicates a step size that corresponds to each frequency component, and Srr(i) indicates a power spectrum that corresponds to each frequency component in the frequency response function in the secondary path. Further, in Equation 5, μ0 of a numerator is a constant, and a value when the control is stable in a frequency band, in which indoor noise is largest, may be selected through a test.

The average value calculation unit 145 may be configured to accumulate and add the filter value variation quantities calculated by the variation calculation unit 143 by a size of N blocks, and may be configured to calculate an average value of the filter value variation quantities from the accumulated and added filter value variation quantities.

According to an exemplary embodiment of the present invention, the adaptive controller 14 may be configured to accumulate the filter value variation quantity, instead of updating the filter value for every sampling. Further, when the filter value variation quantities are accumulated by a predetermined block size, the adaptive controller 14 may be configured to average the accumulated filter value variation quantities and calculate an average value of the filter value variation quantities. The adaptive controller 14 may also be configured to update the filter value using the calculated average value.

The average value calculation unit 145 may be configured to accumulate and add the filter value variation quantities in the unit of a block in response to each frequency component based on Equation 6 below, and calculate the average value (favr(k)) of the filter value variation quantities from the accumulated and added filter value variation quantities as expressed by Equation 7.

$$\begin{matrix}{f}_{sum} ( k ) = μ {\sum }_{i = 0}^{N - 1} {x}_{hat} ( kN + i ) \cdot e ( kN + i ) & Equation 6 \\ {f}_{avr} ( k ) = {f}_{sum} ( k ) / N & Equation 7\end{matrix}$$

In Equations 6 and 7, N is a block size, and k is a block number. Further, xhat(kN+i) indicates a reference signal (x(kN+i)) path-compensated by the path compensation filter 142 during (kN+i)th sampling, and e(kN+i) is an error signal obtained by the error signal obtaining unit 13 during (kN+i)th sampling. Further, μ indicates a step size.

As described above, when the average value of the filter value variation quantities is calculated in the unit of the block, and the filter value is updated based on the calculated average value, the noise control system 10 may be configured to insensitively respond to disturbance compared to an existing method of updating a filter value for every sampling period. Accordingly, a diverging possibility may be decreased, thereby performing stable adaptive control. In Equations 6 and 7, the block size N is a main parameter for determining control performance and control stability during the adaptive control. When the block size N is less than a predetermined size, sensitivity to disturbance of the noise control system 10 may increase, thus causing control stability to deteriorate, and when the block size N is greater than a predetermined size, a convergence speed of the noise control system 10 may decrease, thus causing control performance to deteriorate. Accordingly, setting an appropriate block size N based on control performance and control stability of the noise control system 10 may be desired or necessary. As an illustrative example, the block size N may be set to 10.

The down-sampling unit 146 may be configured to decrease sampling speed of the noise control system 10 in response to the block size. To update the filter value based on the filter value variation quantity calculated in the unit of the block, decreasing a sampling speed in accordance with the block size may be necessary. The decreased sampling speed may be increased again and restored to an original state by the up-sampling unit 148, which is described below, after the filter value is updated. When the filter value variation quantity is calculated in the unit of the block by the average value calculation unit 145, the filter value updating unit 147 may be configured to update the filter value based on the calculated filter value variation quantity. The filter value updating unit 147 may be configured to update the filter value by referring to a current filter value (w(k)) as expressed by Equation 8 below.

w(k+1)=(1−μγ)w(k)+fₐᵥᵣ(k) Equation 8

Wherein, γ is a leaky constant, and w(k) is a current filter value. In a process of updating a filter value so as to minimize the mean average error, an output of the control signal may become larger than a predetermined side, leading to divergence, and limiting the output of the control signal in order to prevent the divergence may be necessary.

Accordingly, in an exemplary embodiment of the present invention, as described above, when the filter value is updated using the leaky constant (γ), the divergence may be prevented or reduced by reducing influence of the current filter value (w(k)). When the leaky constant (γ) is substantial, the divergence may be prevented, to increase the control stability, but the convergence speed decreases, causing control stability to deteriorate. Accordingly, in consideration of control stability and control performance, setting a leaky constant (γ) appropriate to the noise control using the vibration generator 124 may be necessary. For example, the leaky constant (γ) may be set to have a value of about 0.0001 to 0.001.

The up-sampling unit 148 may be configured to restore the sampling speed decreased by the down-sampling unit 146 again to reflect the filter value updated in the unit of the block to the adaptive filter 141 in accordance with every sampling period. Further, the up-sampling unit 148 may be configured to perform a data holding function of maintaining sampled data to a time when next sampling is generated.

Further, in a narrow band feed forward adaptation control algorithm, the adaptive filter 141 may be configured to update a phase and an amplitude of a sine wave configuring the control signal in order to output the control signal to reduce the error signal. Accordingly, the adaptive filter 141 may be configured to update a size of each of the plurality of cosine signals and sine signals included in the reference signal, and add the updated cosine signals and sine signals to simultaneously update a phase and an amplitude of the sine wave configuring the control signal.

Further, the reference signal obtaining unit 11 may be configured to generate a cosine function and a sine function as a set in response to each frequency component configuring noise as illustrated in FIG. 5. Further, the adaptive controller 14 may be configured to calculate a filter value by applying the adaptation control algorithm for each frequency component, apply the calculated filter value to the set of the cosine and sine functions that corresponds to each frequency component, and add result values to generate the control signal.

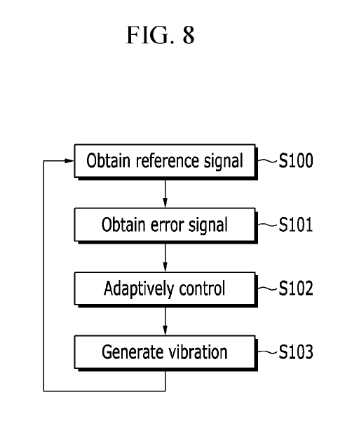

FIG. 8 is an exemplary flowchart illustrating a noise control method according to an exemplary embodiment of the present invention. Referring to FIG. 8, the noise control system may be configured to obtain a reference signal in response to vibration or a sound generated by a noise source using the reference signal obtaining unit 11 (S100). The reference signal may include a plurality of frequency components, and include a cosine signal and a sine signal that correspond to each frequency component. The noise control system 10 may further be configured to obtain an error signal that corresponds to residual noise via the error signal obtaining unit 13 (S101). In operation S101, the error signal is a result of destructive interference between the noise generated by the noise source and a cancellation signal generated by vibration of the vibration generator 124, and may be obtained via a sound sensor or a vibration sensor. In operation S101, the error signal may be obtained via a sound sensor or a vibration sensor. The noise control system 10 may be configured to perform an adaptation control algorithm to output a control signal for cancelling the noise from the reference signal via the adaptive controller 14 (S102).

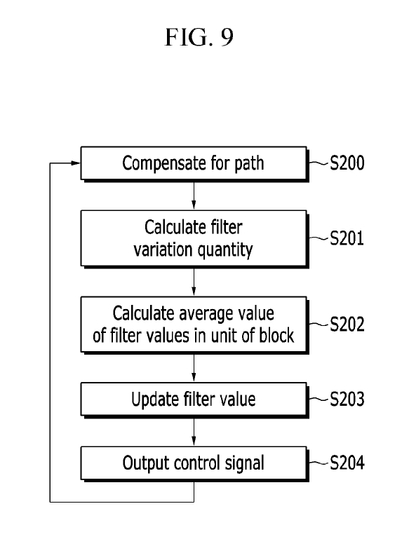

In operation S102, the method of performing the adaptation control algorithm will be described in detail with reference to FIG. 9. When the control signal is generated using the adaptation control algorithm, the generated control signal may be transmitted to the vibration generating unit 12 and input as a drive signal for the vibration generator 124. Accordingly, the vibration generator 124 may be configured to vibrate the panel based on the control signal to generate a radiation sound for cancelling the noise (S103).

FIG. 9 is an exemplary flowchart illustrating a method of performing the adaptation control algorithm by the noise control system according to an exemplary embodiment of the present invention. Referring to FIG. 6, the noise control system 10 may be configured to compensate for a phase delay of the reference signal by using the path compensation filter 142 and output the compensated reference signal (S200). In operation S200, a transfer function used for the compensation of the path may be a transfer function in the secondary path from the vibration generator 124 to the error sensor 131, and a vibration transfer function indicating how excitation force of the vibration generator 124 is transferred in the secondary path may be used. Further, the variation calculation unit 143 of the noise control system 10 may be configured to calculate a filter value variation quantity based on the reference signal, which is path-compensated through operation S200, the error signal obtained via the error signal obtaining unit 13, a step size, and the like (S201). In operation S201, the variation calculation unit 143 may be configured to calculate the filter value variation quantity for each sampling period. In operation S201, the step size may be calculated based on a power spectrum of a frequency response function obtained in the secondary path by the step size calculation unit 144 to prevent the filter value from being diverged without convergence.

Moreover, the noise control system 10 may be executed by a controller and may be configured to accumulate and add the filter value variation quantities calculated for every sampling period by the variation calculation unit 143 by a size of the block through the average value calculation unit 145. Further, the accumulated and added filter value variation values may be divided by the size of the block to calculate an average value of the filter value variation quantities (S202). When the average value is calculated, the noise control system 10 may be configured to update the filter value through the filter value updating unit 147 (S203). In operation S203, the filter value updating unit 147 may update the filter value based on a current filter value and the average value calculated in operation S202. The filter value updating unit 147 may be configured to decrease influence of the current filter value on the updated filter value using the leaky constant, thereby preventing the filter value from being diverged without convergence.

When the filter value is updated, the noise control system 10 may be configured to apply the changed filter value to the adaptive filter 141, and generate a control signal based on the reference signal through the adaptive filter 141 (S204). The generated control signal may be transmitted to the vibration generator 124 to be used for releasing a vibration output for cancelling the noise. In addition, the noise control system 10 may be configured to additionally perform down-sampling for decreasing a sampling speed in order to update the average value, which may be calculated in the unit of the block before operation S203. Further, in order to apply the filter value, which may be updated in the unit of the block, for every sampling period, the up-sampling for restoring the decreased sampling period to an original state may be additionally performed after operation S204.

Since the noise control system using a sound output device, such as a speaker, in the related art controls noise using air-borne noise, a response time of the secondary path (e.g., a path between the sound output device and the error sensor) is substantially short, and the path has consistency, so that the noise control system is appropriate for the application of the adaptation control algorithm. However, such prior art systems suffer from at least one disadvantage in that a noise control system using such a sound output device may not effectively control low frequency sound, such as a booming sound of an engine, thereby giving a user an unnatural and artificial feeling. By contrast, the noise control system 10 according to an exemplary embodiment of the present invention may vibrate the panel through the vibration generator 124, and remove the noise by using a radiation sound generated by the vibration of the panel, thereby effectively controlling low frequency noise so that a user may be subjected to a more natural experience.

However, a response time of the secondary path (the path from the vibration generator to the error sensor) is substantially long, and the noise control system 10 is sensitive to any disturbance due to the controlling of ambient noise using structure-borne noise. A noise control system 10 according to an exemplary embodiment of the present invention may be configured to perform path compensation for the reference function using a transfer function obtained by measuring how excitation force of the vibration generator 124 is transferred through a structure in the secondary path. Further, the step size of the adaptation control algorithm may be calculated based on the frequency response function measured in the secondary path to be used, and the filter value may be updated in the unit of the block to prevent the control signal from being diverged without convergence by decreasing sensitivity to disturbance. In other words, it may be possible to improve control stability of the noise control system 10.

A noise control method according to an exemplary embodiment of the present invention may be executed using software. When the noise control method is executed using software, the constituent means of the present invention may be implemented as code segments for executing operations. A program or the code segments may be stored in a processor-readable function medium, or transmitted by a computer data signal combined with a carrier wave in a transmission medium or a communication network.

The accompanying drawings and the detailed description of the invention are merely an example of the present invention, which are used for the purpose of describing the present invention but are not used to limit the meanings or a scope of the present invention described in claims. Accordingly, those skilled in the art will appreciate that various modifications and equivalent another exemplary embodiment may be possible. Further, those skilled in the art may omit some of the constituent elements described in the present specification without deterioration of performance, or add a constituent element for improving performance. In addition, those skilled in the art may change an order of the operations of the method described in the present specification according to a process environment or equipment. Accordingly, the scope of the present invention shall be determined by the claims and an equivalent thereof, not by the described implementation exemplary embodiments.

### DESCRIPTION OF SYMBOLS

1: Engine
10: Noise control system
11: Reference signal obtaining unit
12: Vibration generating unit
13: Error signal obtaining unit
14: Adaptive controller
121: Digital to analog (DA) converter
122: Low pass filter (LPF)
123: Drive amplifier
124: Vibration generator
131: Error sensor
132: Signal conditioner
133: Low pass filter (LPF)
134: Analog to digital (AD) converter
138: Accelerometer
139: Microphone
141: Path compensation filter
142: Variation calculation unit
143: Step size calculation unit
145: Down-sampling unit
147: Up-sampling unit
148: Adaptive filter

What is claimed is:

1. A system for controlling noise, comprising:
a memory configured to store program instructions; and
a processor configured to execute the program instructions, the program instructions when executed configured to:
receive a reference signal in response to noise generated by a noise source;
receive an error signal that corresponds to residual noise;
generate a control signal for cancelling the noise based on the reference signal;
compensate for a phase delay of the reference signal;
update a filter value of the adaptive filter based on the reference signal passing through the path compensation filter and the error signal; and
output vibration according to the control signal to generate a cancellation signal for cancelling the noise.

2. The system of claim 1, wherein the error signal is received from a sound sensor, and the phase delay of the reference signal is compensated for based on a vibro-acoustic transfer function in a path from an excitation position of the output vibration to a detection position of the error signal.

3. The system of claim 2, wherein the vibration-acoustic transfer function is determined by excitation force of the output vibration and a sound pressure of a sound generated by the excitation force and detected by the sound sensor.

4. The system of claim 2, wherein the vibration-acoustic transfer function is determined by vibration acceleration of a panel configured to vibrate by excitation force against the excitation force of the output vibration, and a sound pressure of a sound generated by vibration of the panel and detected by the sound sensor against the vibration acceleration of the panel.

5. The system of claim 1, wherein the error signal is received from a vibration sensor, and the phase delay of the reference signal is compensated for based on a vibro-vibro transfer function in a path from an excitation position of the output vibration to a detection position of the error signal.

6. The system of claim 5, wherein the vibro-vibro transfer function is determined by an excitation force of the output vibration and vibration acceleration detected in response to the excitation force by the vibration sensor.

7. The system of claim 5, wherein the vibro-vibro transfer function is determined by a sound pressure of a sound generated by excitation force against the excitation force of the output vibration and vibration acceleration detected in response to the excitation force by the vibration sensor against the sound pressure.

8. The system of claim 1, wherein the program instructions when executed are further configured to:
calculate a filter value variation quantity based on the reference signal passing through the path compensation filter and the error signal; and
calculate an average value of the filter value variation quantities in a unit of a block with a predetermined size, and
update the adaptive filter based on the average value and a current filter value.

9. The system of claim 8, wherein the program instructions when executed are further configured to:
calculate a step size based on a power spectrum of a frequency response function obtained in a path from an excitation position of the output vibration and a detection position of the error signal;
calculate the filter value variation quantity based on the step size.

10. The system of claim 8, wherein the program instructions when executed are further configured to:
decrease an influence of the current filter value by using a leaky constant while updating a filter value.

11. A method of controlling noise of a noise control system, comprising:
receiving, by a controller, a reference signal in response to noise generated by a noise source;
generating, by the controller, a control signal for cancelling noise by the noise source based on the reference signal through an adaptive filter;
vibrating, by the controller, a vibration generator according to the control signal to generate a cancellation signal for cancelling the noise;
compensating for a phase delay of the reference signal, by the controller; and
updating, by the controller, a filter value of the adaptive filter based on the reference signal and the error signal, wherein the phase delay of the filter value is compensated for; and
receiving, by the controller, an error signal that corresponds to residual noise.

12. The method of claim 11, wherein the error signal is received via a sound sensor, and the phase delay of the reference signal is compensated for based on a vibro-acoustic transfer function in a path from an excitation position of the output vibration to a detection position of the error signal.

13. The method of claim 12, wherein the vibro-acoustic transfer function is determined by an excitation force of the output vibration and a sound pressure of a sound generated by the excitation force and detected by the sound sensor.

14. The method of claim 12, wherein the vibro-acoustic transfer function is determined by vibration acceleration of a panel which vibrates by excitation force against the excitation force of the output vibration, and a sound pressure of a sound generated by vibration of the panel and detected by the sound sensor against the vibration acceleration of the panel.

15. The method of claim 11, wherein the error signal is obtained through a vibration sensor, and the compensating includes compensating for the phase delay of the reference signal based on a vibro-vibro transfer function in a path from an excitation position of the vibration generator to a detection position of the error signal.

16. The method of claim 15, wherein the vibro-vibro transfer function is determined by an excitation force of the vibration generator, and a vibration acceleration detected in response to the excitation force by the vibration sensor.

17. The method of claim 15, wherein the vibro-vibro transfer function is determined by a sound pressure of a sound generated by excitation force against the excitation force of the vibration generator, and vibration acceleration detected in response to the excitation force by the vibration sensor against the sound pressure.

18. The method of claim 11, wherein the updating of the filter value includes:
calculating a filter value variation quantity based on the reference signal and the error signal, wherein a phase delay of the filter value variation is compensated for;
calculating an average value of the filter value variation quantities in a unit of a block having a predetermined size; and
updating the adaptive filter based on the average value and a current filter value.

19. The method of claim 18, wherein the adaptively controlling further includes:
calculating a step size based on a power spectrum of a frequency response function obtained in a path from an excitation position of the vibration generator and a detection position of the error signal, and
the calculating of the filter value variation quantity includes calculating the filter value variation quantity based on the step size.

20. The method of claim 18, wherein the updating of the adaptive filter includes applying a leaky constant to the current filter value.

21. A non-transitory computer readable medium containing program instructions executed by a controller, the computer readable medium comprising:
program instructions that receive a reference signal in response to noise generated by a noise source;
program instructions that generate a control signal for cancelling noise by the noise source based on the reference signal through an adaptive filter;
program instructions that vibrate a vibration generator according to the control signal to generate a cancellation signal for cancelling the noise;
program instructions that compensate for a phase delay of the reference signal; and
program instructions that update a filter value of the adaptive filter based on the reference signal and the error signal, wherein the phase delay of the filter value is compensated for; and
program instructions that receive an error signal that corresponds to residual noise.

22. The non-transitory computer readable medium of claim 21 wherein the program instructions when executed are further configured to:
calculate a filter value variation quantity based on the reference signal passing through the path compensation filter and the error signal; and
calculate an average value of the filter value variation quantities in a unit of a block with a predetermined size, and
update the adaptive filter based on the average value and a current filter value.

23. The non-transitory computer readable medium of claim 22 wherein the program instructions when executed are further configured to:
calculate a step size based on a power spectrum of a frequency response function obtained in a path from an excitation position of the output vibration and a detection position of the error signal;
calculate the filter value variation quantity based on the step size.
